(19) United States
(12) Patent Application Publication
(10) Pub. No.: US 2026/0194426 A1
(43) Pub. Date: Jul. 9, 2026

(54) STAINING METHOD, LIQUID COMPOSITION FOR STAINING, AND KIT FOR STAINING

(71) Applicant: CANON KABUSHIKI KAISHA, Tokyo (JP)

(72) Inventors: MASANOBU OOTSUKA, Tokyo (JP); WAKA HASEGAWA, Tokyo (JP); MASARU SUGITA, Tokyo (JP); JUNJI ITO, Kanagawa (JP); KEIGO MIZUSAWA, Tokyo (JP)

(21) Appl. No.: 19/555,101

(22) Filed: Mar. 3, 2026

Related U.S. Application Data
(63) Continuation of application No. PCT/JP2024/031684, filed on Sep. 4, 2024.

(30) Foreign Application Priority Data
Sep. 8, 2023 (JP) 2023-146445
Aug. 20, 2024 (JP) 2024-139231

(51) Int. Cl. G01N 1/31; G01N 1/30

(52) U.S. Cl. CPC G01N 1/31; G01N 2001/302

(57) ABSTRACT

Provided is a method that can stain a biological sample with a staining liquid ejected by an inkjet system. Provided is a staining method characterized by including a step of ejecting a liquid composition including a ligand protein having specificity for a target in a biological sample, at least one kind selected from an amino acid and a salt thereof, a surfactant, and water from a liquid ejection head of an inkjet system to apply the liquid composition to the biological sample.

### CROSS-REFERENCE TO RELATED APPLICATIONS

This application is a Continuation of International Patent Application No. PCT/JP2024/031684, filed Sep. 4, 2024, which claims the benefit of Japanese Patent Application No. 2023-146445, filed Sep. 8, 2023, and Japanese Patent Application No. 2024-139231, filed Aug. 20, 2024, all of which are hereby incorporated by reference herein in their entirety.

### BACKGROUND

### Field of the Technology

The present disclosure relates to a staining method for staining a biological sample, a liquid composition for staining, and a kit for staining. Specifically, the present disclosure relates to a staining method characterized by including a step of ejecting a liquid composition including a ligand protein having specificity for a target in a biological sample, at least one kind selected from an amino acid and a salt thereof, a surfactant, and water from a liquid ejection head of an inkjet system to apply the liquid composition to the biological sample, a liquid composition used for the staining, and a kit used for the staining.

### Description of the Related Art

The development of molecular biology in recent years has increased the importance of the analysis of substances present in living bodies. For example, many attempts have been made to elucidate proteins and chemical substances involved in recurrence and metastasis from cancer tissue sections.

Observation with a microscope is often used as an approach to analyzing a protein or a chemical substance in a biological sample, such as a cell or a tissue. In this case, as an approach to identifying a target, such as a protein or a chemical substance, in a biological sample, there has been used a method involving labeling the target via a protein (ligand protein) having specificity for the target, such as an antibody, followed by detection based on color development, luminescence, fluorescence, or the like.

There is a method of applying a liquid composition including a ligand protein to a target with a pipette dispenser. However, the washing of the pipette and a replacement site therefor are required, and hence the apparatus becomes larger. Accordingly, there is a demand for downsizing the apparatus.

In Japanese Patent Laid-Open No. 2018-517895, there is a disclosure of a method of dispensing reagent droplets each having a volume ranging from about 1 μL to about 50 μL onto a biological sample. In addition, in Japanese Patent Laid-Open No. 2018-517895, there is a disclosure of a method of dispensing the reagent droplets by inkjet.

In Japanese Patent Laid-Open No. 2018-517895, droplets of an antibody reagent composition or the like are applied by inkjet to perform immunostaining. The inventors ejected the antibody reagent composition described in Japanese Patent Laid-Open No. 2018-517895 by an inkjet system. As a result, particularly when the antibody reagent composition is ejected at a high frequency, that is, when the antibody reagent composition is ejected at short ejection intervals, the ejection volume of the antibody reagent composition has been significantly smaller than its intended droplet volume in some cases.

### SUMMARY

The present disclosure is directed to providing a staining method, a liquid composition for staining, and a kit for staining each of which can apply a ligand protein having specificity for a target in a biological sample in a desired droplet volume through ejection by an inkjet system, that is, can apply the protein in an efficient liquid volume.

The present disclosure provides a staining method for staining a biological sample. More specifically, the staining method is characterized by including a step of ejecting a liquid composition including a ligand protein having specificity for a target in a biological sample, at least one kind selected from an amino acid and a salt thereof, a surfactant, and water from a liquid ejection head of an inkjet system to apply the liquid composition to the biological sample.

The present disclosure also provides a liquid composition for staining a biological sample. More specifically, the liquid composition includes: a ligand protein having specificity for a target in a biological sample; at least one kind selected from an amino acid and a salt thereof; a surfactant; and water. The present disclosure also provides a kit for staining a biological sample. More specifically, the kit is a kit for staining a biological sample by using an inkjet system, the kit including a liquid composition including: a ligand protein having specificity for a target in the biological sample; at least one kind selected kind from an amino acid and a salt thereof; a surfactant; and water.

Features of the present disclosure will become apparent from the following description of embodiments.

### DESCRIPTION OF THE EMBODIMENTS

The present disclosure provides, as a first embodiment, a staining method characterized by including a step of ejecting a liquid composition including a ligand protein having specificity for a target in a biological sample, at least one kind selected from an amino acid and a salt thereof, a surfactant, and water from a liquid ejection head of an inkjet system to apply the liquid composition to the biological sample.

A case in which a thermal inkjet system is used as the inkjet system is described. The repeatability of a liquid ejection unit can be increased because the orifice diameter of an ejection orifice, the heat amount of a thermal pulse used for ejection, the size accuracy of a micro-heater or the like used therefor are high. A plurality of liquid ejection units are arranged at a high density on a head. Meanwhile, the droplet diameter distribution of an ejected liquid can be narrowed over all of the plurality of liquid ejection units because the repeatability of the liquid ejection unit can be increased as described above. In addition, manufacturing cost for the head is low and its versatility is high. For example, there is a demand for a small ejection apparatus in which the head is appropriately replaced before use, and the applicability of the head to such ejection apparatus is also high. Accordingly, when the downsizing or convenience of an ejection apparatus is required, a thermal inkjet ejection apparatus is particularly preferred.

However, an investigation made by the inventors has recognized that when a liquid composition including a protein is ejected by a thermal inkjet system without addition of any additive, its ejection volume significantly reduces as compared to a protein-free liquid in a high frequency region of from 5 kHz to 50 kHz, though the degree of the reduction depends on the kind and concentration of the protein.

Although a cause for the significant reduction in ejection volume is not certain, the inventors have conceived the cause to be as described below. It has been known that a protein generally has such a higher-order structure that its hydrophobic moiety is folded. When the protein is adsorbed on a heater part via the hydrophobic moiety, insoluble matter temporarily precipitates owing to heating. The re-dissolution of the insoluble matter into water is partially late for the next driving of the heater. The inventors have assumed that the significant reduction in ejection volume is observed because only part of the heater part is heated.

In addition, concern is raised in that the physiological activity of the ligand protein, which has been heated at the heater part and once insolubilized, reduces.

In order to eject a large amount of a liquid efficiently, the liquid needs to be ejected at a frequency higher than a certain level. The frequency at which the heater part is driven in this embodiment is preferably from 0.1 kHz to 100 kHz, more preferably from 1 kHz to 50 kHz.

The inventors have made extensive investigations, and as a result, have succeeded in achieving both the maintenance of the physiological activity of the ligand protein and the securement of a sufficient ejection volume by adding at least one kind selected from an amino acid and a salt thereof, and a surfactant to a liquid composition including the ligand protein.

Although a cause allowing the combination of the amino acid and the surfactant to sufficiently contribute to the securement of the sufficient ejection volume has not been clarified, the cause is assumed to be as described below.

The amino acid weakly interacts with the protein in water. Accordingly, the protein is covered with the amino acid, and hence can significantly suppress the precipitation of insoluble matter at the heated heater part. In addition, trace insoluble matter deposited on the heater can be instantly re-dissolved by the coexisting surfactant, and hence the heater can maintain a clean state. Thus, the protein deposited on the heater part can be prevented from solidifying to cause clogging. The inventors have conceived that a sufficient ejection volume can be secured by the above-mentioned effects.

### <Biological Sample>

The biological sample in this embodiment is not particularly limited as long as the biological sample may contain the target for which the specificity of the ligand protein can function. Examples thereof may include: cultured cells; body fluids (e.g., blood, serum, plasma, spinal fluid, sweat, saliva, and urine), hair, excretions, organs, and tissues of animals; animals and plants themselves; samples obtained by fixation thereof, followed by paraffin embedding; and dried products thereof. In addition, the examples may include river water, lake water, sea water, tap water and sewage water, and soil each of which contains a substance of biological origin and may contain the target for which the specificity of the ligand protein to be applied can function.

The biological sample may be immobilized on a solid phase. When the biological sample is immobilized on the solid phase, a step of removing an excess liquid composition through a washing step or the like can be conveniently performed after the application of the liquid composition.

Examples of the solid phase include, but not limited to, polystyrene resin particles, nylon resin particles, glass particles, a glass flat plate, a polystyrene microplate, latex particles, various magnetic particles, metal particles, metal-coated particles, a metal flat plate, a metal-coated flat plate, various porous materials, and various electrodes. Of those, a glass flat plate such as a glass slide is suitably used.

A product obtained by subjecting the solid phase to surface modification to strengthen the binding between the solid phase and the biological sample is suitably used in this embodiment. The binding between the solid phase and the biological sample is not particularly limited as long as the specificity of the ligand protein for the target in the biological sample is not inhibited. An example of the surface modification of the solid phase is addition of a functional group, such as an amino group, a carboxyl group, a thiol group, a disulfide group, or a hydroxy group, or addition of a compound having a particular amino acid sequence.

In addition, a solid phase suppressed from nonspecific adsorption by subjecting the solid phase to hydrophilic treatment is suitably used in this embodiment.

### <Amino Acid>

The amino acid refers to a compound having an amino group and a carboxyl group around a carbon atom, and a derivative thereof. In this embodiment, the amino acid is not particularly limited, and may be any of a hydrophilic amino acid, a hydrophobic amino acid, a neutral amino acid, an acidic amino acid, a basic amino acid, a branched amino acid, an aromatic amino acid, a sulfur-containing amino acid, and the like. In addition, its molecular weight is not limited, and D-form and L-form thereof are also not limited. Twenty kinds of amino acids for forming proteins and peptides for forming a living body, namely, alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, and salts thereof are preferred.

Of the amino acids, arginine, lysine, glycine, proline, glutamic acid, aspartic acid, valine, threonine, alanine, and salts thereof are more preferred. Of those, arginine, lysine, glycine, and salts thereof are particularly preferred.

The L-form or D-form of the amino acid used in the present disclosure does not matter.

Examples of the salts of acidic to neutral amino acids may include: alkali metal salts, such as sodium and potassium salts; and ammonium salts. In addition, examples of the salts of neutral to basic amino acids may include: a hydrochloride; a sulfate; a phosphate; a nitrate; a carboxylate including a fatty acid, such as acetic acid or lauric acid; and an oxalate. Preferred examples of the salts of acidic amino acids include sodium salts, potassium salts, and ammonium salts, preferred examples of the salts of neutral amino acids include sodium salts and potassium salts, and preferred examples of the salts of basic amino acids include a hydrochloride, an acetate, and a fatty acid salt.

### <Surfactant>

The surfactant is used without any particular limitation. Examples thereof include: anionic surfactants, such as a sodium alkyl sulfonate, a sodium alkylbenzene sulfonate, a sodium dialkyl sulfosuccinate, and a sodium alkylcarboxylate; nonionic surfactants, such as an acetylene glycol-based surfactant represented by the formula (1), a polyoxyethylene alkyl ether, a polyoxyethylene alkylphenyl ether, a polyoxyethylene alkyl ester, a polyoxyethylene polyoxypropylene glycol, a sorbitan alkyl ester, polyoxyethylene sorbitan alkyl ester, a glycerin alkyl ester, an alcohol alkoxylate, and a polyoxyethylene hydrogenated castor oil; cationic surfactants, such as an alkyltrimethylammonium chloride, an alkyltrimethylammonium bromide, a dialkyldimethylammonium chloride, and an alkylbenzyldimethylammonium chloride; and amphoteric surfactants, such as an alkyl betaine, an alkyl dimethylamine oxide, and a cholate derivative. Further, polymer-type surfactants, such as a sodium salt of a naphthalenesulfonic acid formalin condensate and sodium polyacrylate, may each be used.

The following radical polymerizable compound may also be used: an ionic group, such as a sulfonic acid group, a carboxylic acid group, or an amino group, or a hydrophilic nonionic group, such as a polyoxyethylene group or a polyglyceryl group, is bonded to the radical polymerizable compound to impart surfactant activity thereto.

An acetylene glycol-based surfactant having a structure represented by the formula (1) is particularly preferred as the surfactant. Commercially available examples of the surfactant represented by the formula (1) may include: Acetylenol E13T, E40, E60, E100, and E200 (all of which are manufactured by Kawaken Fine Chemicals Co., Ltd.); and Surfynol 465 and 485 (all of which are manufactured by Nissin Chemical Co., Ltd.).

It is conceived that the surfactant represented by the formula (1) undergoes fast orientation and adsorption to an interface between a heat generating element such as a heater and the liquid composition, and hence suppresses the adsorption of the protein to the heat generating element. In addition, it is conceived that the orientation and adsorption of the surfactant represented by the formula (1) are fast with respect to a protein adhering to the heat generating element and having its hydrophobic surface exposed. It is conceived that, through this action, the surfactant represented by the formula (1) suppresses the deposition of the protein on the heat generating element, thus contributing to the stabilization of ejection.

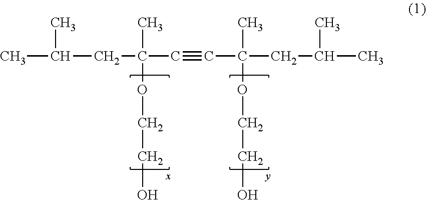

In the formula (1), “x” and “y” satisfy the relationship of 1.0≤x+y≤30.0.

The addition amount of each of the surfactants is set to preferably 0.01 mass % or more and 3 mass % or less, more preferably 0.05 mass % or more and 0.40 mass % or less with respect to the total mass of the liquid composition.

### <Inkjet>

A method of applying the liquid composition in this embodiment is characterized by including a step of ejecting the liquid composition from a liquid ejection head of an inkjet system (also referred to simply as “inkjet”) to apply the liquid composition to the biological sample.

Examples of the liquid ejection head may include: a mode in which the liquid composition is ejected by causing film boiling to occur in the liquid composition with an electro-thermal converter to form air bubbles; a mode in which the liquid composition is ejected with an electro-mechanical converter; and a mode in which the liquid composition is ejected through utilization of static electricity. Of those, a liquid ejection head utilizing an electro-thermal converter, that is, including a heat generating element that applies thermal energy to the liquid composition is preferred from the viewpoint of performing high-speed and high-density printing.

In an inkjet system that ejects a liquid composition from a liquid ejection head through the action of thermal energy, when a liquid composition including a protein is brought into contact with a heat generating element, the protein adheres to the heat generating element in some cases. When this phenomenon continues, the protein is deposited on the heat generating element. As a result, the action of the thermal energy becomes difficult to transmit to the liquid composition, causing a reduction in ejection volume, an ejection failure, or the like in some cases.

<Protein having Specificity for Target>

In this embodiment, the liquid composition includes the ligand protein having specificity for a target. Herein, a molecule having specificity for a target is referred to as “ligand”, and a protein having specificity for a target is referred to as “ligand protein”.

In addition, the phrase “having specificity for a target” means that a dissociation constant with the target is 1 μM or less. The ligand protein to be used for staining is not particularly limited as long as the ligand protein has a dissociation constant of 1 μM or less for the target, and examples thereof include an enzyme, an antibody, an antigen protein, a receptor, a cytokine, a hormone, and a serum protein.

The ligand protein may be a known protein except the foregoing, or may be a novel protein. The ligand protein to be used for the staining of this embodiment is particularly preferably an antibody or an antibody fragment from the viewpoints of a low dissociation constant and structural stability of a molecule.

### <Antibody and Antibody Fragment>

The term “antibody” is a collective term for an immunoglobulin family induced by an immune system in response to a particular antigen or substance, and is a substance capable of recognizing a particular target and binding to the target. The antibody may be obtained from any of various animal species, such as a mouse, a rabbit, a goat, a camel, and a human. In addition, a humanized antibody, a chimeric antibody, or the like may be used. In addition, the antibody may be any of a monoclonal antibody and polyclonal antibodies.

The term “antibody fragment” refers to part of an antibody, the part being capable of specifically binding to a target molecule. Examples of the antibody fragment include a Fab fragment, a Fab′ fragment, F(ab′)2, a heavy chain variable (VH) region alone, a light chain variable (VL) region alone, a complex of VH and VL, or a camelized VH domain, or a peptide containing a complementarity-determining region (CDR) of an antibody, and a single-chain antibody (scfv) obtained by linking a heavy chain variable region and a light chain variable region.

### <Labeling Substance>

The ligand protein is preferably modified with a labeling substance. When the ligand protein is modified with the labeling substance, the presence position of the target in the biological sample can be recognized after staining. Herein, the term “modified” refers to physical adsorption of the ligand protein and the labeling substance, chemical bonding thereof, or both physical adsorption and chemical bonding thereof.

The modification of the ligand protein with the labeling substance may be performed by a method, such as a physical adsorption method, a chemical bonding method, or combined use thereof.

An example of the physical adsorption method is a method involving mixing the ligand protein and the labeling substance in a solution such as a buffer solution to bring the ligand protein and the labeling substance into contact with each other. For example, when the labeling substance is colloidal gold or latex, the physical adsorption method is effective, and the ligand protein and the colloidal gold may be mixed in a buffer solution to be brought into contact with each other, to thereby provide a colloidal gold-labeled ligand protein.

An example of the chemical bonding method is a method involving causing the ligand protein and the labeling substance to be mixed and brought into contact with a bifunctional crosslinking reagent, such as glutaraldehyde, a carbodiimide, an imide ester, or maleimide, to thereby allow the crosslinking reagent to react with an amino group, a carboxyl group, a thiol group, an aldehyde group, a hydroxy group, or the like of each of both of the antibody and the labeling substance. In addition, there is given a method involving producing a derivative obtained by bonding a carbodiimide to the labeling substance, and allowing the derivative to react with an amino group of the ligand protein. For example, when the labeling substance is a fluorescent substance, an enzyme, or a chemiluminescent substance, the chemical bonding method is effective.

Examples of the labeling substance include a low-molecular-weight compound, fine particles, an enzyme, a fluorescent dye, and a fluorescent protein.

Specific examples of the low-molecular-weight compound include biotin, digoxigenin, and dinitrophenyl.

Specific examples of the fine particles include colloidal gold, ferrite particles, latex beads, ferrite-encapsulated latex beads, fluorescent substance-encapsulated latex beads, and agarose beads.

Specific examples of the enzyme include horseradish peroxidase, alkaline phosphatase, β-galactosidase, and luciferase.

Specific examples of the fluorescent dye include Cy3, Cy5, Texas Red, fluorescein, Indocyanine Green, and an Alexa dye (e.g., Alexa 568). In addition, a rare earth fluorescent complex such as a europium complex may be used. Specific examples of the fluorescent protein include a green fluorescent protein (GFP) and derivatives thereof, R-phycoerythrin, and allophycocyanin.

Of those, at least one selected from the group consisting of: biotin; an enzyme; a fluorescent dye; and a fluorescent protein is preferred as the labeling substance. That is, the ligand protein is preferably modified with at least one labeling substance selected from the group consisting of: biotin; an enzyme; a fluorescent dye; and a fluorescent protein.

In addition, a plurality of the materials given above may be used as the labeling substance. In addition, a material except those given above may be used.

### <Blocking Agent>

A so-called blocking agent may be used in order to suppress nonspecific adsorption of the ligand protein onto a portion except the target at the time of the staining of the biological sample with the ligand protein. When the blocking agent is incorporated into the liquid composition together with ligand protein, a satisfactory staining result can be obtained. Examples of the blocking agent include bovine serum albumin, casein, an animal serum, gelatin, fat-free milk, polyvinyl alcohol, polyvinylpyrrolidone, polyethylene glycol, a phospholipid, and compounds containing the above-mentioned substances. Of those, at least one selected from the group consisting of: bovine serum albumin; and casein is preferred as the blocking agent. In addition, a commercially available blocking agent may be used. In particular, the content of the blocking agent in the liquid composition is preferably 0.1 mass % or more and 10 mass % or less with respect to the total mass of the liquid composition. When a protein is used as the blocking agent, the total content of proteins including the ligand protein in the liquid composition is set to preferably 0.001 mass % or more and 3 mass % or less, more preferably 0.001 mass % or more and 0.3 mass % or less with respect to the total weight of the liquid composition in consideration of ejection by the inkjet system.

### <Water-Soluble Organic Solvent>

The liquid composition includes: the ligand protein; at least one kind selected from the amino acid and the salt thereof; the surfactant; and the water. A water-soluble organic solvent may be further added to the liquid composition as required for the purpose of stabilizing its ejection. Examples of the water-soluble organic solvent may include alcohols, polyalkylene glycols, glycol ethers, nitrogen-containing compounds, and sulfur-containing compounds. Specific examples thereof include glycerin (290° C.), dimethyl sulfoxide (DMSO) (189° C.), ethylene glycol (197° C.), diethylene glycol (245° C.), polyethylene glycol having an average molecular weight of 600 (200° C. or more), propylene glycol (187° C.), triethylene glycol (244° C.), 1,2-pentanediol (187° C.), 1,2-hexanediol (223° C.), ethylene glycol monobutyl ether (171° C.), diethylene glycol monobutyl ether (180° C.), 2-pyrrolidone (245° C.), triethanolamine (208° C.), and thiodiglycol (282° C.). A boiling point is shown in the parentheses.

In this embodiment, it is preferred to use, as the water-soluble organic solvent, a water-soluble organic solvent having a boiling point of 180° C. or more. The incorporation of the organic solvent having a boiling point of 180° C. or more can effectively suppress the evaporation of a liquid component from an ejection orifice. Two or more kinds selected from those solvents may be used as a mixture.

The content of the water-soluble organic solvent in the liquid composition is preferably 5 mass % or more and 30 mass % or less, more preferably 10 mass % or more and 20 mass % or less with respect to the total mass of the liquid composition.

### <Second Liquid Composition>

The staining method in this embodiment may further include a step of applying a second liquid composition to the biological sample having the first liquid composition applied thereto.

The second liquid composition includes a protein (second protein) having specificity for the ligand protein (first protein) in the liquid composition described above (first liquid composition). The phrase “having specificity for the ligand protein” means that a dissociation constant with the ligand protein is 1 μM or less. For example, when the ligand protein in the first liquid composition is a rabbit-derived antibody, a goat-derived anti-rabbit antibody may be used as the ligand protein in the second liquid composition. In addition, for example, when the ligand protein in the first liquid composition is a biotin-labeled rabbit-derived antibody, avidin and streptavidin as well as the goat-derived anti-rabbit antibody may each be used as the ligand protein of the second liquid composition.

The second protein is preferably modified with the above-mentioned labeling substance. This is because the use of the second protein modified with the labeling substance obviates the need to modify the first protein with the labeling substance, allowing the use of such a first protein that its modification with the labeling substance reduces its specificity for the target. The second protein is preferably modified with at least one selected from the group consisting of: biotin; an enzyme; a fluorescent dye; and a fluorescent protein.

An inkjet method, which is a method of applying the first liquid composition, may be used as a method of applying the second liquid composition. That is, a method including ejecting the second liquid composition from a liquid ejection head of an inkjet system may be used. In addition, a method involving application by contact through use of a gravure roll or a blade, or a method involving non-contact application by dropping with a spray or a pipette may be used.

From the viewpoint of preventing damage to the biological sample, a method involving application by a non-contact method is preferred.

### <Substrate>

When an enzyme, such as horseradish peroxidase or alkaline phosphatase, is used as the labeling substance, color development may be performed by using a chromogenic substrate that reacts with the enzyme. A combination of an enzyme and a chromogenic/luminescent substrate for the enzyme may also be used. Examples of the enzyme include luciferase, horseradish peroxidase, and alkaline phosphatase. Color development may be performed by combining the following color developers as substrates therefor. Examples thereof include luciferin, 3,3′-diaminobenzidine (DAB), 5-bromo-4-chloro-3-indolyl phosphate (BCIP), 3,3′-(3,3′-dimethoxy-4,4′-biphenylene) bis [2-(4-nitrophenyl)-5-phenyl-2H-tetrazolium chloride] (NBT).

Accordingly, when the ligand protein is modified with an enzyme, the staining method according to this embodiment preferably further includes a step of applying a substrate for the enzyme to the biological sample having applied thereto the liquid composition including the ligand protein. In addition, in a case in which: the staining method according to this embodiment includes the step of applying the first liquid composition to the biological sample and the step of applying the second liquid composition; the first protein (ligand protein) in the first liquid composition is not modified with any enzyme; and the second protein is modified with an enzyme, it is preferred that the method further include a step of applying a substrate for the enzyme to the biological sample having the first liquid composition and the second liquid composition applied thereto. In addition, the substrate for the enzyme may be incorporated into a third liquid composition.

### <Buffer Solution>

A buffer solution may be used as the solvent of the liquid composition. Examples thereof include, but not limited to, various buffer solutions, such as a phosphate buffer solution, a glycine buffer solution, a Good's buffer solution, a Tris buffer solution, and an ammonia buffer solution. The use of the buffer solution suppresses a change in pH to improve the storage stability of the ligand protein.

In addition, the liquid composition may include a salt. Examples thereof include, but not limited to, a sodium salt such as sodium chloride, a potassium salt such as potassium chloride, and a magnesium salt such as magnesium chloride. Nonspecific adsorption except the binding between the target and the ligand protein having specificity for the target can be suppressed by adjusting the concentration of the salt.

### <Washing Step>

The method preferably includes a washing step of separating the ligand protein unreacted with the biological sample from the sample after the application of the ligand protein having specificity for the target to the biological sample. When the washing step is performed, color development or the like due to the ligand protein remaining at a site except the target can be suppressed, and hence the position of the target can be made clear in observation after staining.

### <Others>

The liquid composition may include, in addition to the above-mentioned components, various additives, such as an antifoaming agent, a surfactant, a pH adjuster, a viscosity modifier, a corrosion inhibitor, a preservative, an antifungal agent, an antioxidant, a reduction inhibitor, and a chelating agent, as required.

In addition, the liquid composition may include, in addition to the above-mentioned components, a water-soluble organic solvent that is a solid at 25° C., such as urea and derivatives thereof, polyethylene glycol having an average molecular weight of 1,000 or more, trimethylolpropane, and trimethylolethane.

In addition, the present disclosure provides, as a second embodiment, a liquid composition including: a ligand protein having specificity for a target in a biological sample; at least one kind selected from an amino acid and a salt thereof; a surfactant; and water. In addition, the present disclosure provides, as a third embodiment, a kit for staining a biological sample by using an inkjet system, the kit including a liquid composition including: a ligand protein having specificity for a target in a biological sample; at least one kind selected from an amino acid and a salt thereof; a surfactant; and water.

In the kit, the ligand protein having specificity for the target, at least one kind selected from the amino acid and the salt thereof, the surfactant, and the water may be mixed to form the liquid composition, or may be separate. In addition, the components may be incorporated into a container alone or as a mixture thereof. In addition, the kit may further include a diluent, a blocking agent, a positive control, a negative control, an instruction manual, and the like. Examples of the positive control include a tissue section and a liquid sample each of which evidently contains a measurable target. In addition, the kit may further include a cartridge container configured to be mountable onto an ejection head of an inkjet system.

### EXAMPLES

The embodiments of the present disclosure are described in more detail below by way of Examples and Comparative Examples. The present disclosure is by no means limited to the following Examples, and various modifications may be made without departing from the gist of the present disclosure. In the following description of Examples, the term “part(s)” means part(s) by mass unless otherwise specified.

### <Biological Sample 1>

HER2-IHC Posicon Slide (PS-17001, Pathology Institute Corp.) was used as a biological sample 1. Four kinds of cultured cell lines, namely, negative “0”, weakly positive “1+”, moderately positive “2+”, and strongly positive “3+” cell lines are attached to the commercially available slide in accordance with the expression level of a HER2 protein.

### <Preparation of Buffer Solution>

An aqueous solution of 50 mM Tris base and an aqueous solution of 150 mM sodium chloride were mixed, and the whole was adjusted to a pH of 7.6 with hydrochloric acid, followed by pressure filtration through a sterilizing filter having a pore size of 0.22 μm to prepare a buffer solution. The buffer solution is hereinafter referred to as “TBS buffer.” Various ligand proteins, various surfactants, and a solid solvent were dissolved in the buffer solution in advance before preparation.

### <Ligand Proteins>

Polyclonal rabbit-derived anti-human HER2 antibodies (A0485, manufactured by Dako) were used as a ligand protein 1. HER2 refers to human epidermal growth factor receptor-2 (human epidermal growth factor-2).

A monoclonal rabbit-derived anti-human HER2 antibody (4290, manufactured by Cell Signaling Technology, Inc.) was used as a ligand protein 2.

A product obtained by subjecting F(ab′)2, which had been obtained by digesting polyclonal rabbit-derived anti-human HER2 antibodies (A0485, manufactured by Dako) with pepsin, to FITC labeling was used as a ligand protein 3. The F(ab′)2 was produced in accordance with the following protocol. First, the antibodies were dialyzed against a 0.1 M sodium acetate buffer solution (pH 3.75). After that, porcine gastric mucosa-derived pepsin-immobilized agarose (product of Sigma-Aldrich Co. LLC) was added, and the mixture was subjected to a reaction at 37° C. for 3 hours. After that, a 0.5 M Tris buffer solution (pH 8.0) was added to a pH of 7.0 to stop the reaction. The pepsin-immobilized agarose was removed by a centrifugal separation method. Further, the solution was passed through a protein A-immobilized agarose column (Thermo Fisher Scientific Inc.). The resultant was dialyzed against a TBS buffer at room temperature for 2 hours to provide a F(ab′)2 solution. Further, Fluorescein Labeling Kit-NH₂ (product name, Dojindo Laboratories) was used in accordance with the manufacturer's protocol to prepare FITC-labeled F(ab′)2.

A ligand protein obtained by labeling polyclonal rabbit-derived anti-human HER2 antibodies (A0485, manufactured by Dako) with biotin was used as a ligand protein 4. The biotin labeling was performed by using Biotin Labeling Kit-NH₂ (product name, Dojindo Laboratories) in accordance with the manufacturer's protocol to prepare biotin-labeled polyclonal rabbit-derived anti-human HER2 antibodies.

A ligand protein obtained by labeling polyclonal rabbit-derived anti-human HER2 antibodies (A0485, manufactured by Dako) with horseradish peroxidase was used as a ligand protein 5. The enzyme labeling was performed by using Peroxidase Labeling Kit-NH₂ (product name, Dojindo Laboratories) in accordance with the manufacturer's protocol to prepare horseradish peroxidase-labeled polyclonal rabbit-derived anti-human HER2 antibodies.

A ligand protein obtained by labeling polyclonal rabbit-derived anti-human HER2 antibodies (A0485, manufactured by Dako) with alkaline phosphatase was used as a ligand protein 6. The enzyme labeling was performed by using Alkaline Phosphatase Labeling Kit-NH₂ (product name, Dojindo Laboratories) in accordance with the manufacturer's protocol to prepare alkaline phosphatase-labeled polyclonal rabbit-derived anti-human HER2 antibodies.

Fluorescein Labeling Kit-NH₂ (product name, Dojindo Laboratories) was used for polyclonal rabbit-derived anti-human HER2 antibodies (A0485, manufactured by Dako) in accordance with the manufacturer's protocol to prepare FITC-labeled polyclonal rabbit-derived anti-human HER2 antibodies as a ligand protein 7.

R-Phycoerythrin Labeling Kit-NH₂ (product name, Dojindo Laboratories) was used for polyclonal rabbit-derived anti-human HER2 antibodies (A0485, manufactured by Dako) in accordance with the manufacturer's protocol to prepare R-phycoerythrin-labeled polyclonal rabbit-derived anti-human HER2 antibodies as a ligand protein 8.

Dual Link System-HRP (HRP-labeled polymer reagent) (K4063, Dako) was prepared and used as it was as a ligand protein 9.

FITC-labeled streptavidin (Funakoshi Co., Ltd.) was prepared as a ligand protein 10.

Biotin-labeled goat-derived anti-rabbit IgG (Funakoshi Co., Ltd.) was prepared as a ligand protein 11.

HRP-labeled goat-derived anti-rabbit IgG (Funakoshi Co., Ltd.) was prepared as a ligand protein 12.

FITC-labeled goat-derived anti-rabbit IgG (Funakoshi Co., Ltd.) was prepared as a ligand protein 13.

R-Phycoerythrin-labeled goat-derived anti-rabbit IgG (Funakoshi Co., Ltd.) was prepared as a ligand protein 14.

<Protein Except Ligand Protein (Blocking Agent)>

Bovine serum albumin (BSA, Sigma-Aldrich Co. LLC) was used as a protein except a ligand protein.

### <Surfactant>

The following surfactants shown in (a) to (h) were used.
(a) A-E100: Acetylenol E100 (manufactured by Kawaken Fine Chemicals Co., Ltd.), which is a compound that satisfies x+y=10 in the formula (1).
(b) A-E40: Acetylenol E40 (manufactured by Kawaken Fine Chemicals Co., Ltd.), which is a compound that satisfies x+y=4 in the formula (1).
(c) Tween 80 (manufactured by Tokyo Chemical Industry Co., Ltd.), which has a polyoxyethylene sorbitan alkyl ester-based structure and is not the surfactant represented by the formula (1).
(d) BIO-SOFT N91-8 (manufactured by Stepan Company), which has an alcohol alkoxylate-based structure and is not the surfactant represented by the formula (1).
(e) Triton-X100 (manufactured by Merck Millipore), which has a polyoxyethylene alkylphenyl ether-based structure and is not the surfactant represented by the formula (1).
(f) SDS: sodium dodecyl sulfate (manufactured by FUJIFILM Wako Pure Chemical Corporation), which is not the surfactant represented by the formula (1).
(g) CTAB: cetyltrimethylammonium bromide (manufactured by Tokyo Chemical Industry Co., Ltd.), which has an alkyltrimethylammonium bromide-based structure and is not the surfactant represented by the formula (1).
(h) CHAPS: 3-[3-(cholamidopropyl)dimethylammonio]propanesulfonic acid (manufactured by Dojindo Laboratories), which is an amphoteric surfactant of a cholate derivative and is not the surfactant represented by the formula (1).

### <Substrate>

The following substrates were used.
(a) Liquid DAB+ (product name: K3465, manufactured by Dako)
(b) BCIP-NBT Solution Kit (manufactured by Nacalai Tesque, Inc.)

### <Preparation of First Liquid Composition>

Compositions A-1 to A-49 were each prepared as a first liquid composition by mixing respective components so that their contents were as shown in Table 1 (Table 1-1 to Table 1-8). Numbers in the tables represent solid matter contents (mass %).

TABLE 1-1

| First liquid composition No. | | A-1 | A-2 | A-3 | A-4 | A-5 | A-6 | A-7 |
|---|---|---|---|---|---|---|---|---|
| Ligand protein | Ligand protein 1 | 0.001 | | | | | | |
| | Ligand protein 2 | | 0.001 | | | | | |
| | Ligand protein 3 | | | 0.001 | | | | |
| | Ligand protein 4 | | | | 0.001 | | | |
| | Ligand protein 5 | | | | | 0.001 | | |
| | Ligand protein 6 | | | | | | 0.001 | |
| | Ligand protein 7 | | | | | | | 0.001 |
| | Ligand protein 8 | | | | | | | |
| Protein except | BSA | 0.5 | 0.5 | 0.5 | 0.5 | 0.5 | 0.5 | 0.5 |
| ligand protein | Casein | | | | | | | |
| Amino acid | Lysine | 1 | 1 | 1 | 1 | 1 | 1 | 1 |
| | Arginine | | | | | | | |
| | Glycine | | | | | | | |
| | Glutamic acid | | | | | | | |
| | Aspartic acid | | | | | | | |
| | Valine | | | | | | | |
| | Threonine | | | | | | | |
| | Alanine | | | | | | | |
| | Proline | | | | | | | |
| Water-soluble | Glycerin | 10 | 10 | 10 | 10 | 10 | 10 | 10 |
| organic solvent | Diethylene glycol | | | | | | | |
| | 1,2-Hexanediol | | | | | | | |
| Surfactant | A-E100 | 0.1 | 0.1 | 0.1 | 0.1 | 0.1 | 0.1 | 0.1 |
| | A-E40 | | | | | | | |
| | Tween 80 | | | | | | | |
| | BIO-SOFT N91-8 | | | | | | | |
| | Triton-X | | | | | | | |
| | SDS | | | | | | | |
| | CTAB | | | | | | | |
| | CHAPS | | | | | | | |
| Buffer | TBS | Balance | Balance | Balance | Balance | Balance | Balance | Balance |

TABLE 1-2

| First liquid composition No. | | A-8 | A-9 | A-10 | A-11 | A-12 | A-13 |
|---|---|---|---|---|---|---|---|
| Ligand protein | Ligand protein 1 | | 0.3 | 0.001 | 0.001 | 0.001 | 0.001 |
| | Ligand protein 2 | | | | | | |
| | Ligand protein 3 | | | | | | |
| | Ligand protein 4 | | | | | | |
| | Ligand protein 5 | | | | | | |
| | Ligand protein 6 | | | | | | |
| | Ligand protein 7 | | | | | | |
| | Ligand protein 8 | 0.001 | | | | | |
| Protein except | BSA | 0.5 | 0.5 | | 0.5 | 0.5 | 0.5 |
| ligand protein | Casein | | | 0.5 | | | |
| Amino acid | Lysine | 1 | 1 | 1 | 1 | 1 | 1 |
| | Arginine | | | | | | |
| | Glycine | | | | | | |
| | Glutamic acid | | | | | | |
| | Aspartic acid | | | | | | |
| | Valine | | | | | | |
| | Threonine | | | | | | |
| | Alanine | | | | | | |
| | Proline | | | | | | |
| Water-soluble | Glycerin | 10 | 10 | 10 | | | 0 |
| organic solvent | Diethylene glycol | | | | 10 | | |
| | 1,2-Hexanediol | | | | | 10 | |
| Surfactant | A-E100 | 0.1 | 0.1 | 0.1 | 0.1 | 0.1 | 0.1 |
| | A-E40 | | | | | | |
| | Tween 80 | | | | | | |
| | BIO-SOFT N91-8 | | | | | | |
| | Triton-X | | | | | | |
| | SDS | | | | | | |
| | CTAB | | | | | | |
| | CHAPS | | | | | | |
| Buffer | TBS | Balance | Balance | Balance | Balance | Balance | Balance |

TABLE 1-3

| First liquid composition No. | | A-14 | A-15 | A-16 | A-17 | A-18 | A-19 | A-20 |
|---|---|---|---|---|---|---|---|---|
| Ligand protein | Ligand protein 1 | 0.001 | 0.001 | 0.001 | 0.001 | 0.001 | 0.001 | 0.001 |
| | Ligand protein 2 | | | | | | | |
| | Ligand protein 3 | | | | | | | |
| | Ligand protein 4 | | | | | | | |
| | Ligand protein 5 | | | | | | | |
| | Ligand protein 6 | | | | | | | |
| | Ligand protein 7 | | | | | | | |
| | Ligand protein 8 | | | | | | | |
| Protein except | BSA | 0.5 | 0.5 | 0.5 | 0.5 | 0.5 | 0.5 | 0.5 |
| ligand protein | Casein | | | | | | | |
| Amino acid | Lysine | 1 | 1 | | | | | |
| | Arginine | | | 1 | | | | |
| | Glycine | | | | 1 | | | |
| | Glutamic acid | | | | | 1 | | |
| | Aspartic acid | | | | | | 1 | |
| | Valine | | | | | | | 1 |
| | Threonine | | | | | | | |
| | Alanine | | | | | | | |
| | Proline | | | | | | | |
| Water-soluble | Glycerin | 20 | 30 | 10 | 10 | 10 | 10 | 10 |
| organic solvent | Diethylene glycol | | | | | | | |
| | 1,2-Hexanediol | | | | | | | |
| Surfactant | A-E100 | 0.1 | 0.1 | 0.1 | 0.1 | 0.1 | 0.1 | 0.1 |
| | A-E40 | | | | | | | |
| | Tween 80 | | | | | | | |
| | BIO-SOFT N91-8 | | | | | | | |
| | Triton-X | | | | | | | |
| | SDS | | | | | | | |
| | CTAB | | | | | | | |
| | CHAPS | | | | | | | |
| Buffer | TBS | Balance | Balance | Balance | Balance | Balance | Balance | Balance |

TABLE 1-4

| First liquid composition No. | | A-21 | A-22 | A-23 | A-24 | A-25 | A-26 |
|---|---|---|---|---|---|---|---|
| Ligand protein | Ligand protein 1 | 0.001 | 0.001 | 0.001 | 0.001 | 0.001 | 0.001 |
| | Ligand protein 2 | | | | | | |
| | Ligand protein 3 | | | | | | |
| | Ligand protein 4 | | | | | | |
| | Ligand protein 5 | | | | | | |
| | Ligand protein 6 | | | | | | |
| | Ligand protein 7 | | | | | | |
| | Ligand protein 8 | | | | | | |
| Protein except | BSA | 0.5 | 0.5 | 0.5 | 0.025 | 1.5 | 0 |
| ligand protein | Casein | | | | | | |
| Amino acid | Lysine | | | | 1 | 1 | 1 |
| | Arginine | | | | | | |
| | Glycine | | | | | | |
| | Glutamic acid | | | | | | |
| | Aspartic acid | | | | | | |
| | Valine | | | | | | |
| | Threonine | 1 | | | | | |
| | Alanine | | 1 | | | | |
| | Proline | | | 1 | | | |
| Water-soluble | Glycerin | 10 | 10 | 10 | 10 | 10 | 10 |
| organic solvent | Diethylene glycol | | | | | | |
| | 1,2-Hexanediol | | | | | | |
| Surfactant | A-E100 | 0.1 | 0.1 | 0.1 | 0.1 | 0.1 | 0.1 |
| | A-E40 | | | | | | |
| | Tween 80 | | | | | | |
| | BIO-SOFT N91-8 | | | | | | |
| | Triton-X | | | | | | |
| | SDS | | | | | | |
| | CTAB | | | | | | |
| | CHAPS | | | | | | |
| Buffer | TBS | Balance | Balance | Balance | Balance | Balance | Balance |

TABLE 1-5

| First liquid composition No. | | A-27 | A-28 | A-29 | A-30 | A-31 | A-32 | A-33 |
|---|---|---|---|---|---|---|---|---|
| Ligand protein | Ligand protein 1 | 0.001 | 0.001 | 0.001 | 0.001 | 0.001 | 0.001 | 0.001 |
| | Ligand protein 2 | | | | | | | |
| | Ligand protein 3 | | | | | | | |
| | Ligand protein 4 | | | | | | | |
| | Ligand protein 5 | | | | | | | |
| | Ligand protein 6 | | | | | | | |
| | Ligand protein 7 | | | | | | | |
| | Ligand protein 8 | | | | | | | |
| Protein except | BSA | 0.5 | 0.5 | 0.5 | 0.5 | 0.5 | 0.5 | 0.5 |
| ligand protein | Casein | | | | | | | |
| Amino acid | Lysine | 0.1 | 0.3 | 1.5 | 3 | 5 | 1 | 1 |
| | Arginine | | | | | | | |
| | Glycine | | | | | | | |
| | Glutamic acid | | | | | | | |
| | Aspartic acid | | | | | | | |
| | Valine | | | | | | | |
| | Threonine | | | | | | | |
| | Alanine | | | | | | | |
| | Proline | | | | | | | |
| Water-soluble | Glycerin | 10 | 10 | 10 | 10 | 10 | 10 | 10 |
| organic solvent | Diethylene glycol | | | | | | | |
| | 1,2-Hexanediol | | | | | | | |
| Surfactant | A-E100 | 0.1 | 0.1 | 0.1 | 0.1 | 0.1 | 0.05 | 0.4 |
| | A-E40 | | | | | | | |
| | Tween 80 | | | | | | | |
| | BIO-SOFT N91-8 | | | | | | | |
| | Triton-X | | | | | | | |
| | SDS | | | | | | | |
| | CTAB | | | | | | | |
| | CHAPS | | | | | | | |
| Buffer | TBS | Balance | Balance | Balance | Balance | Balance | Balance | Balance |

TABLE 1-6

| First liquid composition No. | | A-34 | A-35 | A-36 | A-37 | A-38 | A-39 |
|---|---|---|---|---|---|---|---|
| Ligand protein | Ligand protein 1 | 0.001 | 0.001 | 0.001 | 0.001 | 0.001 | 0.001 |
| | Ligand protein 2 | | | | | | |
| | Ligand protein 3 | | | | | | |
| | Ligand protein 4 | | | | | | |
| | Ligand protein 5 | | | | | | |
| | Ligand protein 6 | | | | | | |
| | Ligand protein 7 | | | | | | |
| | Ligand protein 8 | | | | | | |
| Protein except | BSA | 0.5 | 0.5 | 0.5 | 0.5 | 0.5 | 0.5 |
| ligand protein | Casein | | | | | | |
| Amino acid | Lysine | 1 | 1 | 1 | 1 | 1 | 1 |
| | Arginine | | | | | | |
| | Glycine | | | | | | |
| | Glutamic acid | | | | | | |
| | Aspartic acid | | | | | | |
| | Valine | | | | | | |
| | Threonine | | | | | | |
| | Alanine | | | | | | |
| | Proline | | | | | | |
| Water-soluble | Glycerin | 10 | 10 | 10 | 10 | 10 | 10 |
| organic solvent | Diethylene glycol | | | | | | |
| | 1,2-Hexanediol | | | | | | |
| Surfactant | A-E100 | 0.5 | 1 | | | | |
| | A-E40 | | | 0.5 | | | |
| | Tween 80 | | | | 0.5 | | |
| | BIO-SOFT N91-8 | | | | | 0.5 | |
| | Triton-X | | | | | | 0.5 |
| | SDS | | | | | | |
| | CTAB | | | | | | |
| | CHAPS | | | | | | |
| Buffer | TBS | Balance | Balance | Balance | Balance | Balance | Balance |

TABLE 1-7

| First liquid composition No. | | A-40 | A-41 | A-42 | A-43 | A-44 | A-45 |
|---|---|---|---|---|---|---|---|
| Ligand protein | Ligand protein 1 | 0.001 | 0.001 | 0.001 | 0.001 | 0.001 | 0.001 |
| | Ligand protein 2 | | | | | | |
| | Ligand protein 3 | | | | | | |
| | Ligand protein 4 | | | | | | |
| | Ligand protein 5 | | | | | | |
| | Ligand protein 6 | | | | | | |
| | Ligand protein 7 | | | | | | |
| | Ligand protein 8 | | | | | | |
| Protein except ligand | BSA | 0.5 | 0.5 | 0.5 | 0.5 | 0.5 | 0.5 |
| protein | Casein | | | | | | |
| Amino acid | Lysine | 1 | 1 | 1 | 1 | | |
| | Arginine | | | | | | |
| | Glycine | | | | | | |
| | Glutamic acid | | | | | | |
| | Aspartic acid | | | | | | |
| | Valine | | | | | | |
| | Threonine | | | | | | |
| | Alanine | | | | | | |
| | Proline | | | | | 1 | 1 |
| Water-soluble | Glycerin | 10 | 10 | 10 | 10 | 10 | 10 |
| organic solvent | Diethylene glycol | | | | | | |
| | 1,2-Hexanediol | | | | | | |
| Surfactant | A-E100 | | | | 0.5 | 0.5 | |
| | A-E40 | | | | | | |
| | Tween 80 | | | | | | 0.5 |
| | BIO-SOFT N91-8 | | | | | | |
| | Triton-X | | | | | | |
| | SDS | 0.5 | | | | | |
| | CTAB | | 0.5 | | | | |
| | CHAPS | | | 0.5 | | | |
| Buffer | TBS | Balance | Balance | Balance | Balance | Balance | Balance |

TABLE 1-8

| First liquid composition No. | | A-46 | A-47 | A-48 | A-49 |
|---|---|---|---|---|---|
| Ligand protein | Ligand protein 1 | 0.3 | 0.001 | 0 | 0.3 |
| | Ligand protein 2 | | | | |
| | Ligand protein 3 | | | | |
| | Ligand protein 4 | | | | |
| | Ligand protein 5 | | | | |
| | Ligand protein 6 | | | | |
| | Ligand protein 7 | | | | |
| | Ligand protein 8 | | | | |
| Protein except | BSA | 0.5 | 0.5 | 0.5 | 1 |
| ligand protein | Casein | | | | |
| Amino acid | Lysine | 0 | 1 | 1 | |
| | Arginine | | | | |
| | Glycine | | | | |
| | Glutamic acid | | | | |
| | Aspartic acid | | | | |
| | Valine | | | | |
| | Threonine | | | | |
| | Alanine | | | | |
| | Proline | | | | |
| Water-soluble | Glycerin | 10 | 10 | 10 | 50 |
| organic solvent | Diethylene glycol | | | | |
| | 1,2-Hexanediol | | | | |
| Surfactant | A-E100 | 0.1 | | 0.1 | 0.1 |
| | A-E40 | | | | |
| | Tween 80 | | | | |
| | BIO-SOFT N91-8 | | | | |
| | Triton-X | | | | |
| | SDS | | | | |
| | CTAB | | | | |
| | CHAPS | | | | |
| Buffer | TBS | Balance | Balance | Balance | Balance |

### <Preparation of Second Liquid Composition>

Compositions B-1 to B-6 were each prepared as a second liquid composition by mixing respective components so that their contents were as shown in Table 2. Numbers in the table represent solid matter contents. A product supplied by a manufacturer was used as it was as the second liquid composition B-1, and hence a description to that effect is given in Table 2.

TABLE 2

| Second liquid composition No. | | B-1 | B-2 | B-3 | B-4 | B-5 | B-6 |
|---|---|---|---|---|---|---|---|
| Ligand protein | Ligand protein 9 | Manufacturer's | | | | | |
| | | supplied product | | | | | |
| | | used as it is | | | | | |
| | Ligand protein 10 | | 0.001 | | | | |
| | Ligand protein 11 | | | 0.001 | | | |
| | Ligand protein 12 | | | | 0.001 | | |
| | Ligand protein 13 | | | | | 0.001 | |
| | Ligand protein 14 | | | | | | 0.001 |
| Protein except | BSA | | 0.5 | 0.5 | 0.5 | 0.5 | 0.5 |
| ligand protein | | | | | | | |
| Amino acid | Lysine | | 1 | 1 | 1 | 1 | 1 |
| Water-soluble | Glycerin | | 10 | 10 | 10 | 10 | 10 |
| organic solvent | | | | | | | |
| Surfactant | AE100 | | 0.1 | 0.1 | 0.1 | 0.1 | 0.1 |
| Buffer | TBS | | Balance | Balance | Balance | Balance | Balance |

### <Preparation of Third Liquid Composition>

Compositions C-1 to C-3 were prepared as third liquid compositions. The compositions C-1 and C-2 were each prepared by: preparing the corresponding substrate in accordance with the manufacturer's protocol; and then mixing respective components so that their contents were as shown in Table 3. Numbers in the table represent solid matter contents. The same composition as that prepared as the second liquid composition B-2 was used as the composition C-3. The compositions C-1 and C-2 are each free of anv ligand protein.

TABLE 3

| Third liquid composition No. | | C-1 | C-2 |
|---|---|---|---|
| Preparation liquid by | Liquid DAB+ | 89.9 | |
| substrate kit | BCIP-NBT Solution Kit | | 89.9 |
| Water-soluble organic solvent | Glycerin | 10 | 10 |
| Surfactant | AE100 | 0.1 | 0.1 |

### <Biological Sample 2>

Ki-67-IHC Posicon Slide (PS-17004, Pathology Institute Corp.) was used as a biological sample 2. Two kinds of samples, namely, a negative “−” pig liver tissue and a strongly positive “+” cell line-embedded sample, which have different expression levels of a Ki-67 protein, are attached to the commercially available slide.

### <Ligand Protein>

A monoclonal mouse-derived anti-human Ki-67 antibody (M7240, manufactured by Dako) was used as a ligand protein 15. Ki-67 is a protein expressed by a gene present on the long arm of chromosome 10, and has been utilized as a cell proliferation marker because the protein is expressed in all cell nuclei except for a resting phase.

HRP-labeled goat-derived anti-mouse IgG (Funakoshi Co., Ltd.) was prepared as a ligand protein 16.

### <Protein Except Ligand Protein (Blocking Agent)>

Bovine serum albumin (BSA, Sigma-Aldrich Co. LLC) was used as a protein except a ligand protein.

### <Surfactant>

The following surfactant shown in (a) was used.
(a) A-E100: Acetylenol E100 (manufactured by Kawaken Fine Chemicals Co., Ltd.)

### <Substrate>

The following substrates were used.
(a) Liquid DAB+ (product name: K3465, manufactured by Dako)
(b) BCIP-NBT Solution Kit (manufactured by Nacalai Tesque, Inc.)

### <Preparation of First Liquid Composition>

A first liquid composition A-50 was prepared with a TBS buffer solution so as to contain 0.001 mass % of the ligand protein 15, 0.5 mass % of BSA, 1 mass % of lysine, 10 mass % of glycerin, and 0.1 mass % of the surfactant A-E100.

### <Preparation of Second Liquid Composition>

A second liquid composition B-7 was prepared with a TBS buffer solution so as to contain 0.001 mass % of the ligand protein 16, 0.5 mass % of BSA, 1 mass % of lysine, 10 mass % of glycerin, and 0.1 mass % of the surfactant A-E100.

### (Ejection Volume Evaluation)

A liquid ejection head of a thermal jet system having a nozzle diameter of 3 μm was prepared, and a tank connected thereto was filled with BC-345Bk ink (manufactured by CANON KABUSHIKI KAISHA). The liquid ejection head was driven by a controller electrically connected to the ejection head to eject the liquid from an ejection orifice at a frequency of 15 kHz and a voltage of 13 volts. The ejected liquid was observed with an ultra-high-speed camera, and its volume was calculated by a ligament method. The calculated volume was defined as 100%.

Subsequently, the liquid compositions A-1 to A-50, the liquid compositions B-1 to B-7, and the liquid compositions C-1 and C-2 were ejected under the same conditions, and the ejection volumes of the ejected liquids were evaluated based on the following criteria.

### Evaluation Criteria

A: 95% or more
B: 90% or more and less than 95%
C: 70% or more and less than 90%
D: 40% or more and less than 70%
E: Less than 40%

The evaluation results of the ejection volumes of the liquid compositions A-1 to A-50, B-1 to B-7, and C-1 and C-2 are shown in Table 4.

TABLE 4

| | First liquid composition No. | | | | | | | | | | | | |
|---|---|---|---|---|---|---|---|---|---|---|---|---|---|
| | A-1 | A-2 | A-3 | A-4 | A-5 | A-6 | A-7 | A-8 | A-9 | A-10 | A-11 | A-12 | A-13 |
| Ejection volume | A | A | A | A | A | A | A | A | A | A | A | A | B |
| | First liquid composition No. | | | | | | | | | | | | |
| | A-14 | A-15 | A-16 | A-17 | A-18 | A-19 | A-20 | A-21 | A-22 | A-23 | A-24 | A-25 | A-26 |
| Ejection volume | A | A | A | A | B | B | B | B | B | B | A | D | A |
| | First liquid composition No. | | | | | | | | | | | | |
| | A-27 | A-28 | A-29 | A-30 | A-31 | A-32 | A-33 | A-34 | A-35 | A-36 | A-37 | A-38 | A-39 |
| Ejection volume | B | A | A | A | A | A | A | A | A | A | A | A | A |

| | First liquid composition No. | | | | | | | | | | |
|---|---|---|---|---|---|---|---|---|---|---|---|
| | A-40 | A-41 | A-42 | A-43 | A-44 | A-45 | A-46 | A-47 | A-48 | A-49 | A-50 |
| Ejection volume | A | A | A | A | B | C | E | E | A | E | A |

Second liquid composition No.

| | B-1 | B-2 | B-3 | B-4 | B-5 | B-6 | B-7 |
|---|---|---|---|---|---|---|---|
| Ejection volume | E | A | A | A | A | A | A |

Third liquid composition No.

| | C-1 | C-2 |
|---|---|---|
| Ejection volume | A | A |

### <Evaluation of Staining Gradation>

Cells were stained with the respective liquid compositions.

As a result of observation, the staining gradations of the cells were evaluated based on the following criteria.

Evaluation results are shown in Table 5 (Table 5-1 to Table 5-9).

When the biological sample 1 was used, the evaluation was performed based on the following criteria.
A: The cells were stained clearly in stages in accordance with the expression levels of HER2 “0”, “1+”, “2+”, and “3+”, and hence it was easy to determine whether the cells were negative, weakly positive, moderately positive, or strongly positive.
B: The cells were stained in stages in accordance with the HER2 expression levels, and hence it was able to determine whether the cells were negative, weakly positive, moderately positive, or strongly positive.
C: It was difficult to determine whether the cells were negative or weakly positive because the cells were stained in stages in accordance with the expression levels of HER2 “0”, s “2+”, and “3+”, but a difference between the expression levels of “0” and “1+” was unclear.
D: It was difficult to determine whether the cells were negative, weakly positive, or moderately positive because the cells were stained in stages in accordance with the expression levels of HER2 “0” and “3+”, but a difference among the expression levels of “0”, “1+”, and “2+” was unclear.
E: It was impossible to determine whether the cells were negative, weakly positive, moderately positive, or strongly positive because a difference among the expression levels of HER2 “0”, “1+”, “2+”, and “3+” was unclear.

In addition, when the biological sample 2 was used, the evaluation was performed based on the following criteria.
A: It was easy to determine whether the cells were stained with Ki-67 “−” or “+”.
E: It was difficult to determine whether the cells were stained with Ki-67 “−” or “+”.

The evaluation results of the staining gradations are shown in Table 5.

TABLE 5-1

| | Example 1 | Example 2 | Example 3 | Example 4 | Example 5 | Example 6 | Example 7 |
|---|---|---|---|---|---|---|---|
| First liquid | A-1 | A-2 | A-3 | A-4 | A-5 | A-6 | A-7 |
| composition No. | | | | | | | |
| Second liquid | B-1 | B-1 | Unused | B-2 | Unused | Unused | Unused |
| composition No. | | | | | | | |
| Third liquid | C-1 | C-1 | Unused | Unused | C-1 | C-2 | Unused |
| composition No. | | | | | | | |
| Staining gradation | A | A | A | A | A | A | A |

TABLE 5-2

| | Example 8 | Example 9 | Example 10 | Example 11 | Example 12 | Example 13 |
|---|---|---|---|---|---|---|
| First liquid | A-8 | A-9 | A-10 | A-11 | A-12 | A-13 |
| composition No. | | | | | | |
| Second liquid | Unused | B-1 | B-1 | B-1 | B-1 | B-1 |
| composition No. | | | | | | |
| Third liquid | Unused | C-1 | C-1 | C-1 | C-1 | C-1 |
| composition No. | | | | | | |
| Staining gradation | A | A | A | A | A | A |

TABLE 5-3

| | Example | Example | Example | Example | Example | Example | Example |
|---|---|---|---|---|---|---|---|
| | 14 | 15 | 16 | 17 | 18 | 19 | 20 |
| First liquid | A-14 | A-15 | A-16 | A-17 | A-18 | A-19 | A-20 |
| composition No. | | | | | | | |
| Second liquid | B-1 | B-1 | B-1 | B-1 | B-1 | B-1 | B-1 |
| composition No. | | | | | | | |
| Third liquid | C-1 | C-1 | C-1 | C-1 | C-1 | C-1 | C-1 |
| composition No. | | | | | | | |
| Staining | A | C | A | A | A | A | A |
| gradation | | | | | | | |

TABLE 5-4

| | Example | Example | Example | Example | Example | Example |
|---|---|---|---|---|---|---|
| | 21 | 22 | 23 | 24 | 25 | 26 |
| First liquid | A-21 | A-22 | A-23 | A-24 | A-25 | A-26 |
| composition No. | | | | | | |
| Second liquid | B-1 | B-1 | B-1 | B-1 | B-1 | B-1 |
| composition No. | | | | | | |
| Third liquid | C-1 | C-1 | C-1 | C-1 | C-1 | C-1 |
| composition No. | | | | | | |
| Staining gradation | A | A | A | C | A | D |

TABLE 5-5

| | Example | Example | Example | Example | Example | Example | Example |
|---|---|---|---|---|---|---|---|
| | 27 | 28 | 29 | 30 | 31 | 32 | 33 |
| First liquid | A-27 | A-28 | A-29 | A-30 | A-31 | A-32 | A-33 |
| composition No. | | | | | | | |
| Second liquid | B-1 | B-1 | B-1 | B-1 | B-1 | B-1 | B-1 |
| composition No. | | | | | | | |
| Third liquid | C-1 | C-1 | C-1 | C-1 | C-1 | C-1 | C-1 |
| composition No. | | | | | | | |
| Staining gradation | A | A | A | B | C | A | A |

TABLE 5-6

| | Example | Example | Example | Example | Example | Example |
|---|---|---|---|---|---|---|
| | 34 | 35 | 36 | 37 | 38 | 39 |
| First liquid | A-34 | A-35 | A-36 | A-37 | A-38 | A-39 |
| composition No. | | | | | | |
| Second liquid | B-1 | B-1 | B-1 | B-1 | B-1 | B-1 |
| composition No. | | | | | | |
| Third liquid | C-1 | C-1 | C-1 | C-1 | C-1 | C-1 |
| composition No. | | | | | | |
| Staining gradation | B | C | B | C | C | C |

TABLE 5-7

| | Example | Example | Example | Example | Example | Example | Example |
|---|---|---|---|---|---|---|---|
| | 40 | 41 | 42 | 43 | 44 | 45 | 46 |
| First liquid | A-40 | A-41 | A-42 | A-43 | A-44 | A-45 | A-1 |
| composition No. | | | | | | | |
| Second liquid | B-1 | B-1 | B-1 | B-1 | B-1 | B-1 | B-3 |
| composition No. | | | | | | | |
| Third liquid | C-1 | C-1 | C-1 | C-1 | C-1 | C-1 | C-3 |
| composition No. | | | | | | | |
| Staining gradation | C | C | C | B | C | D | A |

TABLE 5-8

| | Example | Example | Example | Example | Example | Example |
|---|---|---|---|---|---|---|
| | 47 | 48 | 49 | 50 | 51 | 52 |
| First liquid | A-1 | A-1 | A-1 | A-1 | A-1 | A-50 |
| composition No. | | | | | | |
| Second liquid | B-4 | B-5 | B-6 | B-2 | B-2 | B-7 |
| composition No. | | | | | | |
| Third liquid | C-1 | Unused | Unused | Unused | Unused | C-1 |
| composition No. | | | | | | |
| Staining gradation | A | A | A | A | A | A |

TABLE 5-9

| | Comparative | Comparative | Comparative | Comparative |
|---|---|---|---|---|
| | Example 1 | Example 2 | Example 3 | Example 4 |
| First liquid | A-46 | A-47 | A-48 | A-49 |
| composition | | | | |
| No. | | | | |
| Second liquid | B-1 | B-1 | B-1 | B-1 |
| composition | | | | |
| No. | | | | |
| Third liquid | C-1 | C-1 | C-1 | C-1 |
| composition | | | | |
| No. | | | | |
| Staining | A | A | E | D |
| gradation | | | | |

The deparaffinization treatment steps of the biological samples 1 and 2, the antigen activation treatment steps of the biological samples 1 and 2, the blocking treatment steps of the biological samples 1 and 2, the permeabilization treatment of the biological sample 2, liquid application, and observation were performed as described below.

### (1) Deparaffinization Treatment of Each of Biological Samples 1 and 2

(a) The biological samples 1 and 2 were each immersed in a container having placed therein a xylene substitute Clear Plus (Falma), and the whole was left at rest at room temperature for 5 minutes. In addition, this operation was performed twice.
(b) The samples were each immersed in a container having placed therein 99.5% ethanol (Kishida Chemical Co., Ltd.), and the whole was left at rest at room temperature for 3 minutes. In addition, this operation was performed twice.
(c) The samples were each immersed in a container having placed therein 95% ethanol, and the whole was left at rest at room temperature for 5 minutes. In addition, this operation was performed twice.
(d) The samples were each immersed in a container having placed therein pure water, and the whole was left at rest at room temperature for 1 minute.

### (2) Antigen Activation Treatment of Each of Biological Samples 1 and 2

(a) The biological samples 1 and 2 were each immersed in a “Target Retrieval Solution, pH 9.0” (Dako) solution that had been heated to from 96° C. to 98° C., and the whole was heated for 40 minutes. After the heating, the resultant was left standing to cool to room temperature.
(b) The biological samples 1 and 2 were each immersed in a container having placed therein a TBS buffer, and the whole was left at rest at room temperature for 3 minutes. In addition, this operation was performed twice.
   (3) Blocking Treatment of each of Biological Samples 1 and 2
(a) 100 μL of a peroxidase blocking reagent (Peroxidase-Blocking Solution Dako REAL (Dako)) was dropped onto each of the biological samples 1 and 2, and the whole was left at rest in a moist chamber for 5 minutes.
(b) The biological samples 1 and 2 were each immersed in a container having placed therein a TBS buffer, and the whole was left at rest at room temperature for 3 minutes. In addition, this operation was performed twice. Subsequent steps were performed by using different methods for each Example.

### (4) Permeabilization Treatment of Biological Sample 2

The biological sample 2 was immersed in a TBS buffer having added thereto 0.2 mass % of the surfactant (e), and the whole was left at rest at room temperature for 15 minutes.

For Examples 1 to 52 and Comparative Examples 1 to 4, the following steps were performed in common.

### (1) Application of First Liquid Composition to Each of Biological Samples 1 and 2

(a) A 1 cm² frame was produced with a Pap pen (Liquid Blocker, manufactured by Daido Sangyo Co., Ltd.) so as to surround the four kinds of cultured cell lines having different expression levels of a HER2 protein in the biological sample 1, and so as to surround the two kinds of cultured cell lines having different expression levels of a Ki-67 protein in the biological sample 2.
(b) The first liquid composition was dropped onto each of the biological samples 1 and 2 by being ejected by an inkjet method as shown in Table 5. Specifically, an ink tank for an inkjet printer (product name: TS-203, manufactured by CANON KABUSHIKI KAISHA) was filled with the first liquid composition, and was attached to a print head. After the ejection volume of one droplet had been measured in advance in the ejection volume evaluation, the first liquid composition was dropped into the frame produced with the Pap pen under conditions set so that its amount became 30 μL per 1 cm².

After the dropping, the whole was left at rest in a moist chamber for 60 minutes.
(c) After a lapse of a predetermined period of time, the biological samples 1 and 2 were each immersed in a container having placed therein a TBS buffer, and the whole was left at rest at room temperature for 3 minutes. In addition, this operation was performed twice.

### (2) Application of Second Liquid Composition

(a) As shown in Table 5, after the ejection volume of one droplet had been measured in advance in the ejection volume evaluation, the second liquid composition was dropped into the frame produced with the Pap pen on each of the biological samples 1 and 2 under conditions set so that its amount became 50 μL per 1 cm². The whole was left at rest in a moist chamber for 30 minutes after the dropping. The term “unused” in Table 5 means that the above-mentioned operation was not performed.
(b) The biological samples 1 and 2 were each immersed in a container having placed therein a TBS buffer, and the whole was left at rest at room temperature for 3 minutes. In addition, this operation was performed twice.

### (3) Application of Third Liquid Composition

(a) As shown in Table 5, after the ejection volume of one droplet had been measured in advance in the ejection volume evaluation, the third liquid composition was dropped into the frame produced with the Pap pen on the biological sample 1 under conditions set so that its amount became 50 μL per 1 cm². The whole was left at rest in a moist chamber for 5 minutes. The term “unused” in Table 5 means that the above-mentioned operation was not performed.
(b) The biological sample 1 was immersed in a container having placed therein water that had been subjected to pressure filtration through a sterilizing filter having a pore size of 0.22 μm, and the whole was left at rest at room temperature for 3 minutes. In addition, this operation was performed twice.

### (4) Observation

For each of Examples 1, 2, 5, 6, 9 to 45, and 47, and Comparative Examples 1 to 4, a microscope BZ-X810 (Keyence Corporation) was used. An image was acquired by using a 40× objective lens adapted to bright-field observation.

In each of Examples 3, 4, 7, 8, 46, and 48 to 52, a fluorescence image of the biological sample 1 was acquired by using a 40× objective lens adapted to fluorescence observation and a fluorescence filter unit BZ-X Filter GFP OP-87763 (Keyence Corporation, excitation wavelength: 470 nm, detection wavelength: 525 nm). Next, a phase-contrast image of the biological sample 1 was acquired by using an objective lens adapted to phase-contrast observation and a capacitor for phase-contrast observation. Next, a green substitute color and a gray substitute color were applied to the acquired fluorescence image and phase-contrast image, respectively. After that, the two images were superimposed by an additive composition method to generate one composite image.

In Example 8, a fluorescence image of the biological sample 1 was acquired by using a 40× objective lens adapted to fluorescence observation and a fluorescence filter unit BZ-X Filter TRITC OP-87764 (Keyence Corporation, excitation wavelength: 545 nm, detection wavelength: 605 nm). Next, a phase-contrast image of the biological sample 1 was acquired by using an objective lens adapted to phase-contrast observation and a capacitor for phase-contrast observation. Next, an orange substitute color and a gray substitute color were applied to the acquired fluorescence image and phase-contrast image, respectively. After that, the two images were superimposed by an additive composition method to generate one composite image.

According to the present disclosure, a ligand protein having specificity for a target in a biological sample can be applied in a desired droplet volume through ejection by an inkjet system. That is, the protein can be applied in an efficient liquid volume.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A staining method comprising ejecting a liquid composition including a ligand protein having specificity for a target in a biological sample, at least one kind selected from an amino acid and a salt thereof, a surfactant, and water from a liquid ejection head of an inkjet system to apply the liquid composition to the biological sample.

2. The staining method according to claim 1, wherein the ligand protein includes one of an antibody or an antibody fragment.

3. The staining method according to claim 1, wherein the ligand protein is modified with at least one selected from the group consisting of: biotin; an enzyme; a fluorescent dye; and a fluorescent protein.

4. The staining method according to claim 1,
wherein the ligand protein is modified with an enzyme, and
wherein the staining method further comprises applying a substrate for the enzyme to the biological sample having the liquid composition applied thereto.

5. The staining method according to claim 1, wherein the liquid composition further includes at least one selected from the group consisting of: bovine serum albumin; and casein.

6. The staining method according to claim 1, wherein a content of the ligand protein in the liquid composition is 0.001 mass % or more and 3 mass % or less with respect to a total mass of the liquid composition.

7. The staining method according to claim 1, wherein the surfactant has a structure represented by the following formula (1): 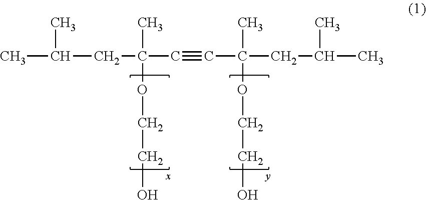
in the formula (1), “x” and “y” satisfy a relationship of 1.05x+y≤30.0.

8. The staining method according to claim 1, wherein a content of the ligand protein in the liquid composition is 0.001 mass % or more and 0.3 mass % or less with respect to a total mass of the liquid composition.

9. The staining method according to claim 1, wherein the amino acid includes at least one kind selected from the group consisting of: arginine; lysine; glycine; proline; glutamic acid; aspartic acid; valine; threonine; and alanine.

10. The staining method according to claim 1, wherein the amino acid includes at least one kind selected from the group consisting of: arginine; lysine; and glycine.

11. The staining method according to claim 1, wherein the liquid composition includes a water-soluble organic solvent.

12. The staining method according to claim 1, further comprising applying, to the biological sample having the liquid composition applied thereto, a second liquid composition including a second protein having specificity for the ligand protein.

13. The staining method according to claim 12, wherein the second protein is modified with at least one selected from the group consisting of: biotin; an enzyme; a fluorescent dye; and a fluorescent protein.

14. The staining method according to claim 12,
wherein the second protein is modified with an enzyme, and
wherein the staining method further comprises applying a chromogenic substrate for the enzyme to the biological sample having the second liquid composition applied thereto.

15. A liquid composition comprising:
a ligand protein having specificity for a target in a biological sample;
at least one kind selected from an amino acid and a salt thereof;
a surfactant; and
water.

16. A kit for staining a biological sample by using an inkjet system, the kit comprising a liquid composition including:
a ligand protein having specificity for a target in a biological sample;
at least one kind selected from an amino acid and a salt thereof;
a surfactant; and
water.

17. The kit according to claim 16, further comprising a cartridge container configured to be mountable onto an ejection head of the inkjet system.
